(19) United States
(12) Patent Application Publication
(10) Pub. No.: US 2009/0199009 A1
(43) Pub. Date: Aug. 6, 2009

(54) Systems, methods and computer program products for authorising ad-hoc access

(76) Inventors: Pei Yen Chia, Singapore (SG); Pek Yew Tan, Singapore (SG)

Correspondence Address: Brinks Hofer Gilson & Lione/Panasonic, P.O. Box 10395, Chicago, IL, 60610, US

(21) Appl. No.: 11/916,740

(22) PCT Filed: Jun. 7, 2005
(86) PCT No.: PCT/SG05/00181

§ 371 Date: May 27, 2008

(51) Int. Cl. H04L 9/32

(52) U.S. Cl. 713/176

(57) ABSTRACT

Methods, systems and computer program products for authorizing ad-hoc access are disclosed. A method for ad-hoc authorization comprising the steps of sending a pre-token via an unsecured communication channel to a device requesting ad-hoc authorization, sending a token associated with the pre-token via a secure communications channel to a proxy for the device, receiving evidence of access by the device to the token and determining the ad-hoc authorization based on the evidence. The systems and computer program products disclosed provide means for practicing the methods disclosed.

### FIELD OF THE INVENTION

The present invention relates generally to methods, systems and computer program products for authorizing ad-hoc access and more particularly to systems, methods and computer program products for granting ad-hoc access to network services and/or network devices.

### BACKGROUND

Network access typically requires users to go through a registration process before network services are provided to those users. Registration is usually carried out by a service administrator who has the right to grant or deny access rights to various potential users. This approach has the disadvantage of having to rely on a service administrator to carry out the registration process.

Authorization to access network-based services can be granted on an ad-hoc basis without requiring a user to go through a tedious registration process. However, a user who accesses a network on an ad-hoc basis is one who needs to access the resources in a network on a temporary basis and may or may not access the same network again at a later time. Generally, ad-hoc users of a network do not have a security association with the network and therefore cannot communicate securely with devices in that network.

One method for granting ad-hoc access to a network device or service is to create a generic account specifically for ad-hoc users, e.g., a guest account. However, use of a common guest account disadvantageously prevents differentiation of access rights between ad-hoc users. In order to enable differentiation of access rights, tokens, certificates or authorization tickets may be used as a means for authorizing a user to access services in a network. Access tokens may be used to allow devices to gain temporary access to a network with restricted privileges.

One system that uses tokens for access control purposes is disclosed in U.S. patent application No. 20030196087, which provides secure access to documents or services residing on a personal network by granting access tokens for temporary access.

Other methods for transferring trust are based on the use of an external, trusted third party. The third party acts as a guarantor for the identity of a party. One such system is the Kerberos protocol, which is a network authentication protocol that enables parties communicating over an unsecured network to prove their identity to one another in a secure manner using secret-key cryptography. For example, Kerberos enables a client to prove its identity to a server and vice-versa across an unsecured network connection and helps to ensure the integrity of the data transferred by preventing or reducing the possibility of eavesdropping or replay attacks.

Another existing system is Smart Right (URL: <www.smartright.org>), which is primarily directed to content protection using smart cards as terminal cards to store user identity. The Smart Right Certification Authority is used to certify the public keys stored in the Smart Right terminal cards.

Other third party trust systems and methods include certificate authorities such as Verisign, Thawte Consulting and Societá per i Servizi Bancari (SSB S.p.A.). A disadvantage of these methods and systems is that an external, trusted third party is required.

Accordingly, a need exists to provide methods, systems and computer program products for authorizing or granting access that do not rely on an external, trusted third party.

A need also exists to provide methods, systems and computer program products for distributing an access token solely to a requesting device or user in an unsecured environment.

### SUMMARY OF THE INVENTION

Aspects of the present invention relate to methods, systems and computer program products for authorizing ad-hoc access.

According to an aspect of the present invention, there is provided a method for granting a requesting device ad-hoc access to a network. The method comprises the steps of sending an access pre-token via an unsecured communication channel to the requesting device, sending an access token associated with the access pre-token via a secure communications channel to a proxy device having a security association with the requesting device and granting ad-hoc network access to the requesting device subject to the requesting device providing information derived from the access token.

The information derived from the access token may comprise information specific to the access token and/or cryptographic key information retrieved from the access token. The method may comprise the further step of forming a security association with the requesting device using the cryptographic key information. The method may comprise the further step of receiving a request for ad-hoc network access from the requesting device via an unsecured communication channel, with the access pre-token and the access token sent in response to the request. The method may comprise the further steps of issuing a challenge to the requesting device and receiving a response to the challenge, the response comprising information derived from the access token. The challenge may comprise a random number and the step of granting ad-hoc network access to the requesting device may be further subject to the response comprising information relating to the random number.

Other aspects of the present invention provide systems and computer program products for implementing a method for granting a requesting device ad-hoc access to a network.

One particular aspect of the present invention provides a system for granting a requesting device ad-hoc access to a network. The system comprises an authorization authority for authorizing access to the network by the requesting device and an authorization controller for granting ad-hoc network access to the authorized requesting device. An access token is sent by the authorization controller via a secure channel to a distribution proxy having a secure association with the requesting device and the authorization is subject to the authorization authority receiving information derived from the access token from the requesting device.

The information derived from the access token may comprise information specific to the access token and/or cryptographic key information retrieved from the access token. The system may further comprise means for forming a security association with the requesting device using the cryptographic key information. The authorization authority may comprise reception means for receiving a request for ad-hoc network access from the requesting device via an unsecured communication channel and transmission means for sending an access pre-token and an access token in response to the request. The authorization authority may comprise transmission means for issuing a challenge to the requesting device and reception means for receiving a response to the challenge from the requesting device.

Other aspects of the present invention provide a method, a system and a computer program product for managing ad-hoc network access. The method comprises the steps of receiving a request for ad-hoc access from a device, which comprises a pre-token sent to the device via an unsecured communication channel; sending a token associated with the pre-token via a secure communications channel to a proxy for the device in response to the request; receiving a communication from the device; and determining whether to grant ad-hoc access to the device based on the content of the communication.

The system and computer program product may be used to practice the method for managing ad-hoc network access.

Yet another aspect of the present invention provides a token for granting a requesting device ad-hoc access to an unsecured network. The token comprises an access pre-token for the requesting device to identify itself to an authorization controller during an ad-hoc request and an access token for enabling the requesting device to validly respond to a challenge issued by the authorization controller to gain ad-hoc access to the unsecured network.

The access pre-token may comprise identification information for matching the access pre-token to the access token. The access pre-token may comprise a key for securing a communication channel during an ad-hoc access request. The access token may comprise information for identifying a network location of the requesting device issuing the ad-hoc access request, identification information for matching the access token to the access pre-token and a key for securing a communication channel between the authorization controller and the requesting device. The access token may comprise a validity tag for indicating validity or invalidity of the access token and/or a validity time for indicating a validity lifetime of the access token. The access pre-token may be used to secure a communications channel when the requesting device issues a request for ad-hoc access to the unsecured network.

### BRIEF DESCRIPTION OF THE DRAWINGS

A small number of embodiments are described hereinafter, by way of example only, with reference to the accompanying drawings in which:

FIG. 1 is a schematic block diagram of a system for authorizing ad-hoc access in a network environment according to an embodiment of the present invention;

FIG. 2 is a sequence diagram of events relating to distribution of an access token in response to a request for ad-hoc network access;

FIG. 3 is a sequence diagram of events relating to granting of ad-hoc network access based on receipt of an access token;

FIG. 4 is a sequence diagram of events relating to configuration of a device as an authorization authority or decision point of a network;

FIG. 5 is a flow diagram of a method for processing an access request accompanied by a pre-token;

FIG. 6 is a sequence diagram of events relating to revocation of network access;

FIG. 7 is a flow diagram of a method for managing ad-hoc network access; and

FIG. 8 is a schematic block diagram of a computer system with which embodiments of the present invention may be practised.

### DETAILED DESCRIPTION OF THE PREFERRED EMBODIMENTS

Embodiments of methods, systems and computer program products are described hereinafter for authorizing and/or granting ad-hoc access to networks.

Certain of the embodiments are described with reference to Personal Area Networks (PANs), which generally comprise the interconnection of network devices within a certain range of an individual, typically 10 meters. Interconnection of devices in a PAN is based on a security association formed either directly or indirectly between the devices. Types of devices include, but are not limited to, laptop computers, notebook computers, personal digital assistants (PDAs) and mobile telephones, which may be interconnected and/or connected to other networks such as the Internet via wires and/or wirelessly. However, it is not intended that the present invention be limited to PANs as the principles of the present invention have general applicability to ad-hoc access of other networks, including known public and private networks.

Use of the term “authorization authority” in this document refers to a decision point, entity or device for authorizing access to a PAN or other network.

Use of the term “authorization controller” in this document refers to an entity or device that is the enforcement point for granting or denying access to a PAN or other network based on a decision of an “authorization authority”.

An authorization authority and an authorization controller may be consolidated in a single device.

Use of the term “distribution proxy” in this document refers to an entity within a PAN or other network of an access requesting device, which provides a secure channel to another PAN or other network which the requesting device is requesting access to.

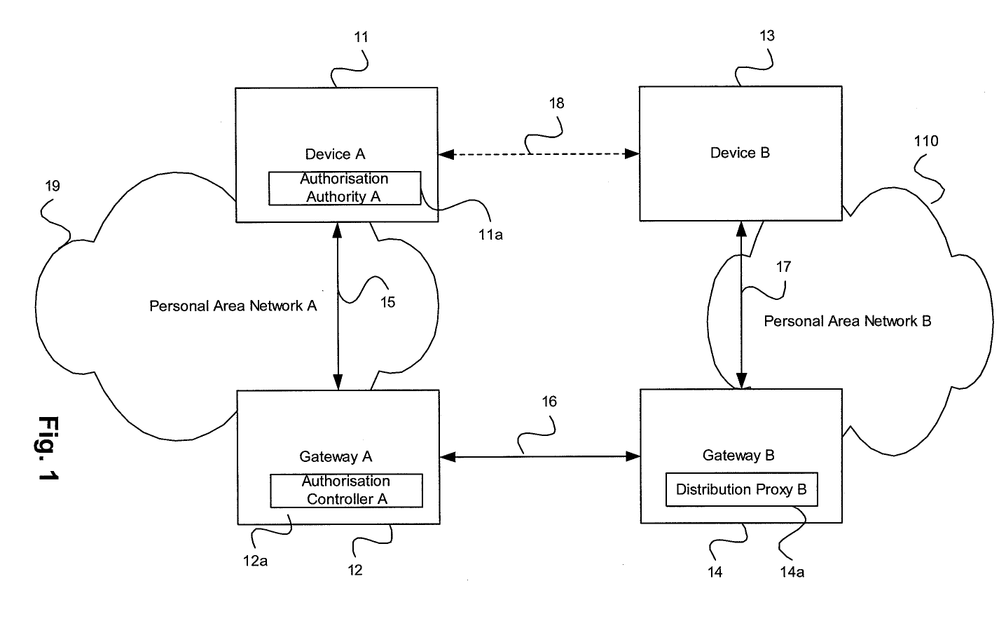

FIG. 1 shows a schematic block diagram of a system for authorizing ad-hoc access in a network environment according to an embodiment of the present invention.

Device 11 and gateway 12 form part of Personal Area Network (PAN) 19 and can communicate securely via internal channel 15. Similarly, device 13 and gateway 14 form part of PAN 110 and can communicate securely via internal channel 17.

Device 11 is configured as an authorization authority 11a for determining whether access to PAN 19 (or devices forming part of PAN 19) should be granted to devices or networks external to PAN 19. Gateway 12 functions as a proxy to PAN 19 for purposes of secure communication with networks or devices external to PAN 19. Gateway 12 is also configured as an authorization controller 12a for enforcing access decisions made by authorization authority 11a.

Gateway 14 functions as a distribution proxy 14a to devices forming part of PAN 110 when those devices communicate with devices external to PAN 110. For example, gateway 14 functions as a distribution proxy 14a for device 13 when device 13 requests ad-hoc access to PAN 19 via an unsecure communications channel 18.

The system shown in FIG. 1 is configured for describing the case of device 13 requesting ad-hoc access to device 11 in PAN 19. Access authorization is required from authorization authority 11a and enforced by authorization controller 12a. However, it will be obvious to persons skilled in the art that different configurations are possible. For example, other entities or devices may be configured to perform functions such as authorization authority and authorization controller. Furthermore, device 13 and gateway 14 may be configured as an authorization authority and an authorization controller, respectively, for dealing with ad-hoc access requests by devices external to PAN 110 such as device 11.

Device 13 and authorization authority 11a do not have a pre-established security association. Thus, device 13 requires authorization from authorization authority 11a to access devices or services (e.g., multimedia services) hosted by devices that form part of PAN 19. However, authorization controller 12a and distribution proxy 14a have a pre-established security association. Thus, any device in PAN 110 having a security association with distribution proxy 14a is able to securely transfer information to PAN 19 via a secure channel 16 that can be formed between authorization controller 12a and distribution proxy 14a. Similarly, any device in PAN 19 having a security association with authorization controller 12a is able to securely transfer information to PAN 110 via secure channel 16.

Security associations may be established by known methods such as those described in an IETF IPSec Working Group document available at URL <http://www.ietf.org/html.charters/ipsec-charter.html>. Once a security association has been established between two devices, the devices can proceed to establish a secure communications channel using known methods at the IP Layer such as IP Tunneling or known methods at the Transport Layer such as Transport Layer Security, Secure Socket Layer (SSL) or a layer 2 tunneling mechanism such as Layer 2 Tunneling Protocol with extensions. Transport Layer Security is described in an IETF document available at URL <http://www.ietf.org/html.charters/tls-charter.html>. Secure Socket Layer (SSL) is described in a draft document available at URL <http://wp.netscape.com/eng/ssl3/draft302.txt>. Layer 2 Tunneling Protocol with Extensions is described in an IETF working group document available at URL <http://www.ietf.org/html.charters/I2tpextcharter.html>. Any of the foregoing methods, combinations of them or other known methods may be used to establish a secure communications channel.

Authorization authority 11a, authorization controller 12a, requesting device 13 and distribution proxy 14a may each be hosted by an independent mobile device (e.g., a PDA or notebook computer system) or an independent static or non-mobile device (e.g., a personal computer workstation). If authorization authority 11a and authorization controller 12a are remote from one another, authorization authority 11a should be capable of forming a remote secure channel with authorization controller 12a for secure communications. For example, a Virtual Private Network (VPN) may be setup between authorization authority 11a and authorization controller 12a. Similarly, a VPN may be setup between requesting device 13 and distribution proxy 14a. Further information regarding VPNs is available in a Virtual Private Networks Consortium document available at URL <http://www.vpnc.org/vpn-standards.html>.

Requesting device 13 and authorization authority 11a cannot communicate securely on account of not having a direct security association. Communications via an unsecured channel are vulnerable to impersonation and man-in-the-middle attacks. Although key exchange may be performed via an unsecured channel (e.g., using public-key encryption methods such as Diffie-Hellman) such communications are also vulnerable to man-in-the-middle attacks.

Embodiments of the present invention use associated pairs of an access token and a pre-token for authorization of ad-hoc network access. In the system of FIG. 1, the pre-token is passed from authorization authority 11a to requesting device 13 across an unsecured network. The pre-token is preferably digitally signed to avoid an integrity attack and is used to identify the associated token. However, it is still possible that other malicious devices will sniff or intercept the pre-token. Therefore, the associated token is passed indirectly via a secure channel to requesting device 13.

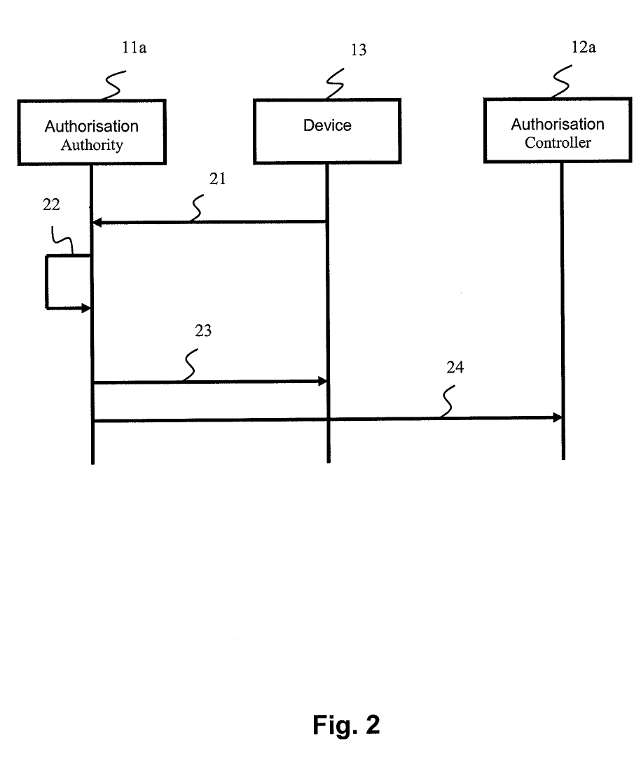

FIG. 2 shows a sequence diagram of events in relation to distribution of an access token in response to a request for ad-hoc network access. Referring to the system of FIG. 1, communications occur between device 13, authorization authority 1 la and authorization controller 12a.

An ad-hoc access request is issued (event 21) by requesting device 13 to authorization authority 11a. Authorization authority 11a processes the request (event 22) and determines whether to grant ad-hoc access to device 13. Processing (event 22) involves the authorization authority 11a matching the requesting device 13 to a list of PAN ID stored in the authorization authority 11a. PAN ID identifies the PAN the authorization controller 12a has a security association with.

Assuming that ad-hoc access is granted, a pre-token is issued (event 23) to requesting device 13 by the authorization authority 11a via an unsecured channel. However, the pre-token can alternatively be issued via a secured channel, for example, using a physical cable, “touch-based” technology, or other existing secure location limited access technology. An access token, associated with the pre-token, is issued (event 24) via a secure channel from authorization authority 11a to authorization controller 12a. The identity of the requesting device 13 and its corresponding PAN ID are sent with the access token to the authorization controller 12a. PAN ID is used by the authorization controller 12a to locate the distribution proxy 14a.

In the embodiment shown in FIG. 2, the access token is issued by authorization authority 11a. However, the token issuer could be any device within the domain of PAN 19, for example, authorization controller 12a. The access token is distributed to the enforcement point within PAN 19, which in this case is Authorization Controller 12a. Other methods for distribution of access tokens may be used providing that the PAN 19 enforcement point, that in the present embodiment is authorization controller 12a, has access to the tokens and the distribution of the tokens is within a secured network within PAN 19.

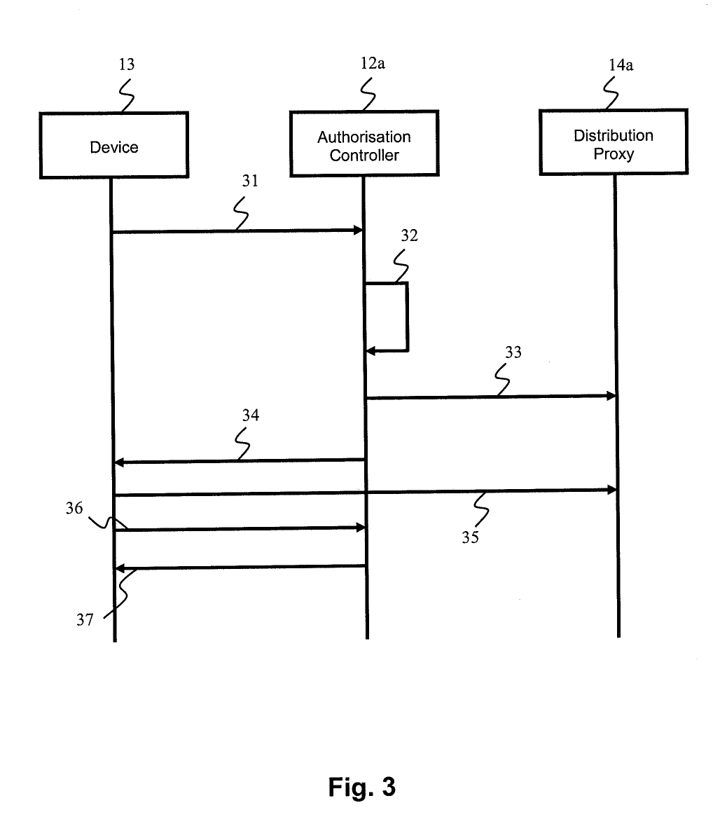

FIG. 3 shows a sequence diagram of events relating to granting of ad-hoc network access based on receipt of an access token. Referring to the system of FIG. 1, communications occur between device 13, authorization controller 12a and distribution proxy 14a.

Requesting device 13 enters the domain of PAN 19 by forwarding an access request accompanied by a pre-token (event 31) to authorization controller 13. The pre-token was previously issued by authorization authority 11a (for example, according to the event 24 in FIG. 2, hereinbefore). The communication channel between requesting device 13 and authorization controller 12a is not secure. However, a secure channel can be established using cryptographic key/s provided with the pre-token in event 31.

Authorization controller 13 processes the access request (event 32) and retrieves the access token associated with the pre-token. The corresponding access token is passed to Distribution Proxy 14a (event 33).

Authorization controller 12a issues a challenge (event 34) with an attached random number to requesting device 13 that requires a response from requesting device 13 that is based on information relating to the access token and the random number. A valid response to the challenge serves as an indication that the responding device has access to the token.

Requesting device 13 retrieves the access token from distribution proxy 14a via a secure channel (event 35). Even if requesting device 13 and distribution proxy 14a are not located in the same domain of PAN 110, a secure link can still be formed if they are virtually in the same domain, for example, via a Virtual Private Network (VPN) as described hereinbefore. Accordingly, the access token is used as a means for authenticating requesting device 13 because only devices which form part of PAN 110 can retrieve the access token from distribution proxy 14a. Other malicious devices not part of PAN 110 would not generally be capable of retrieving the access token from distribution proxy 14a.

The response from requesting device 13 (event 36) to the challenge (event 34) typically contains information derived from the random number and the access token (e.g., a cryptographic key element from the access token). The authorization controller 12a and the requesting device 13 can form a new secure channel using the key element from the access token. Thus, the access token provides a basis for authenticating requesting device 13 and authorizing requesting device 13 to access PAN 19.

The response received from requesting device 13 is processed by authorization controller 12a for verification. Authorization controller 12a is able to verify the response since authorization controller 12a also has the information key element information from the access token and the random number. Successful validation of the response results in authorization of access for requesting device 13 to PAN 19 by authorization controller 12a (event 37).

Numerous methods and algorithms exist for computing and validating the expected response. Algorithms such as SAFER+, which is described in the Specification of the Bluetooth Core System, version 1.1 and is available at URL <http://www.bluetooth.com>, may be used to compute the expected response based on the random number input and a secret key (distributed via access token) shared between authorization controller 12a and requesting device 13.

The embodiment of FIG. 3 involves a 1-way challenge-response. However, a mutual authentication function may alternatively be used whereby requesting device 13 also issues a challenge with an attached random number to authorization controller 12a after authorization controller 12a verifies the response from requesting device 13. Authorization controller 12a is required to respond to the challenge of requesting device 13 based on the random number provided with the challenge issued by requesting device 13 and the shared secret key.

An asynchronous response to challenge system or method enables authorization controller 12a to process other access requests while matching a response with a corresponding access request. However, the time duration between when authorization controller 12a issues a challenge to requesting device 13 and when a response to the challenge is received may be reduced if the pre-token is also attached to the response. This enables authorization controller 12a to more rapidly match the response with the corresponding challenge.

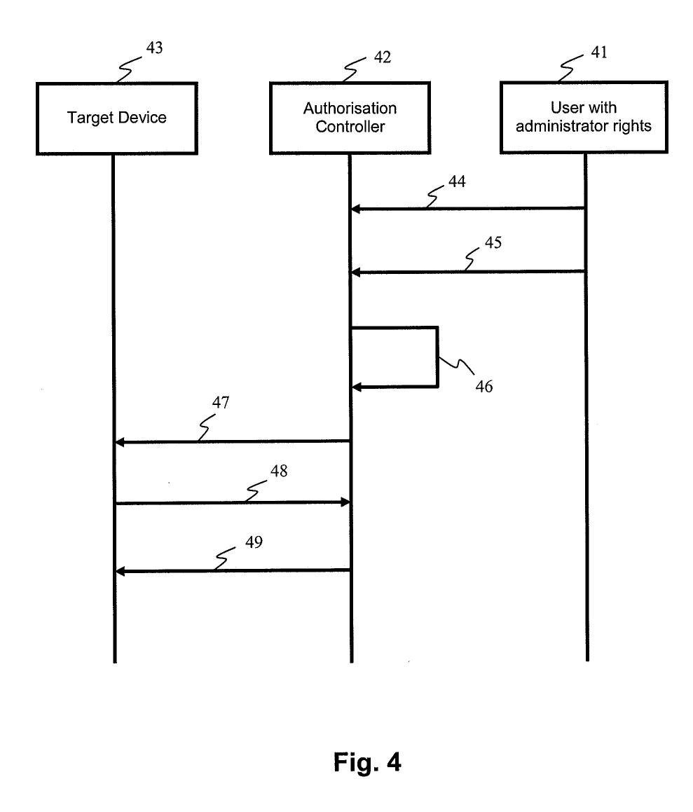

FIG. 4 shows a sequence diagram of events relating to configuration of a device as an authorization authority or decision point of a network. In this embodiment, the initial authorization authority is local to the device that enforces or controls access to the network. A user having administrator rights 41 can change the configuration item in the authorization controller 42. An authority transfer procedure or function is used to transfer the decision point from the authorization controller 42 to another target device 43.

Referring to FIG. 4, a user having administrator rights 41 logs in to the authorization controller 42 (event 44) using the administrator ID, administrator password and also the administrator key. The administrator ID, administrator password and administrator key are pre-determined with an option to change the values. The user 41 invokes the authority transfer function (event 45) to configure an external target device 43 to function as an authorization authority for authorization controller 42. The authorization controller 42 is provided with the ID and address of the target device to which the authority is to be transferred (event 45) to enable the authorization controller 42 to process the transfer of authorization (event 46).

As an example with reference to the embodiment shown in FIG. 1, the authorization controller 12a may be configured to accept device 11 as an authorization authority.

Target device 43 is required to be in the same domain as, and contactable by, authorization controller 42 for the authority transfer to be processed (event 46). After processing, authorization controller 42 initiates a call to target device 43 to respond or acknowledge (event 47). Target device 43 responds by submitting an administrator ID, an administrator password and an administrator key (event 48). If the response from target device 43 is the expected response, then the authority transfer process is complete and confirmation that target device 43 is the new authorization authority for authorization controller 42 is sent to the target device 43 (event 49). The authorization controller 42 may require the target device 43 to submit a device ID in addition to the administrator ID, password and key. As the authority transfer process may be vulnerable to “sniffing” or “eavesdropping” in a wireless environment, a physical link such as a Universal Serial Bus (USB) link provides additional security for this process.

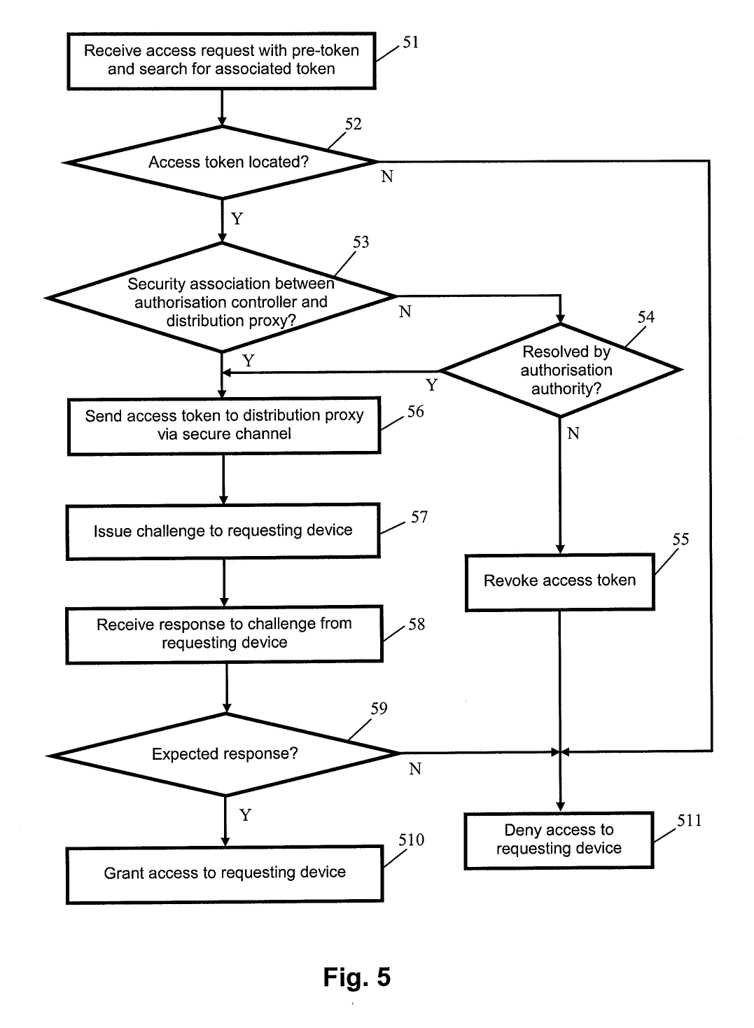

FIG. 5 shows a flow diagram of a method for processing an access request accompanied by a pre-token. The method is described with reference to the system of FIG. 1 but may alternatively be practised with reference to other systems.

At step 51, authorization controller 12a receives an access request with an attached pre-token from a requesting device 13 and searches its token store (in memory) for an access token associated with the pre-token. If an associated access token is not located (N), at step 52, the request for access is denied at step 511.

If an associated access token is located (Y), at step 52, authorization controller 12a determines whether a security association exists between authorization controller 12a and a distribution proxy 14a for the requesting device 13, at step 53. The authorization controller 12a must have a pre-established security association with the distribution proxy 14a in order for the associated access token to be passed securely across a network.

If a security association does not exist (N), the authorization controller 12a refers back to the authorization authority 11a for resolution, at step 54. If the authorization authority 11a is able to resolve the lack of a security association (Y), processing continues at step 56. One possible way of resolving the lack of a security association is for the authorization authority 11a to instruct the authorization controller 12a to form a security association with an appropriate proxy for the requesting device 13. However, if the authorization authority 11a is unable to resolve the lack of a security association (N), the access token is revoked at step 55 and the request for access is denied at step 511.

If a security association does exist (Y), the corresponding access token is sent, at step 56, via a secure channel to the distribution proxy 14a specified by authorization authority 11a.

At step 57, authorization controller 12a issues a challenge to requesting device 13, which may optionally include a random number. A response to the challenge is received from requesting device 13, at step 58, which includes information derived from a key element from the access token and/or the random number. Any requesting device is assumed to be associated with its distribution proxy (e.g., requesting device 13 and distribution proxy 14a. Accordingly, requesting device 13 is able to securely retrieve the access token from distribution proxy 14a. Other malicious devices that do not form part of PAN 110 do not have access to distribution proxy 14a and are thus unable to retrieve the access token. A secure link can be formed between authorization controller 12a and requesting device 13 based on the access token key element. Since authorization controller 12a also has the access token key, authorization controller 12a is thus able to derive the expected response, which may also be based on the random number.

At step 59, a determination is made whether the response from the requesting device 13 is the expected response. If the response is the expected response (Y), then access is granted to requesting device 13 at step 510. If not (N), access is denied at step 511.

An access token may include elements such as validity time or duration and a validity tag for managing the lifetime of the token. A validity tag typically comprises a Boolean flag for indicating whether a related access token is valid (e.g., flag=true) or invalid (e.g., flag=false). When the validity time expires, the token is no longer valid and access is terminated. Alternatively, an authorization authority may revoke access at any point in time.

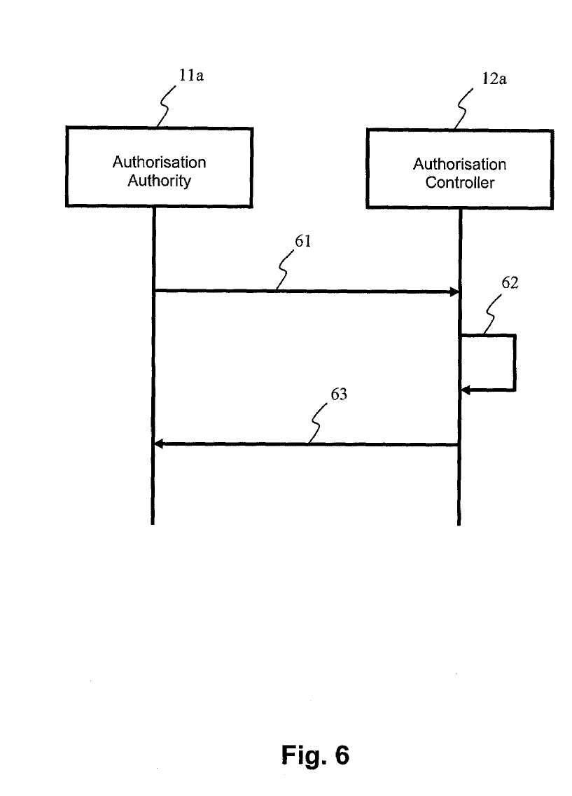

FIG. 6 shows a sequence diagram of events relating to revocation of network access. Referring to the system of FIG. 1, FIG. 6 includes communications between authorization authority 11a and authorization controller 12a.

Authorization authority 11a sends an instruction to authorization controller 12a to invalidate an access token (event 61). Authorization controller 12a processes the instruction and sets the validity tag to “invalid” (event 62). Any ongoing access to PAN 19 by a device using the invalidated token is terminated. Authorization controller 12a sends an acknowledgement to authorization authority 11a when the process of revoking access for the ad-hoc user is completed (event 63).

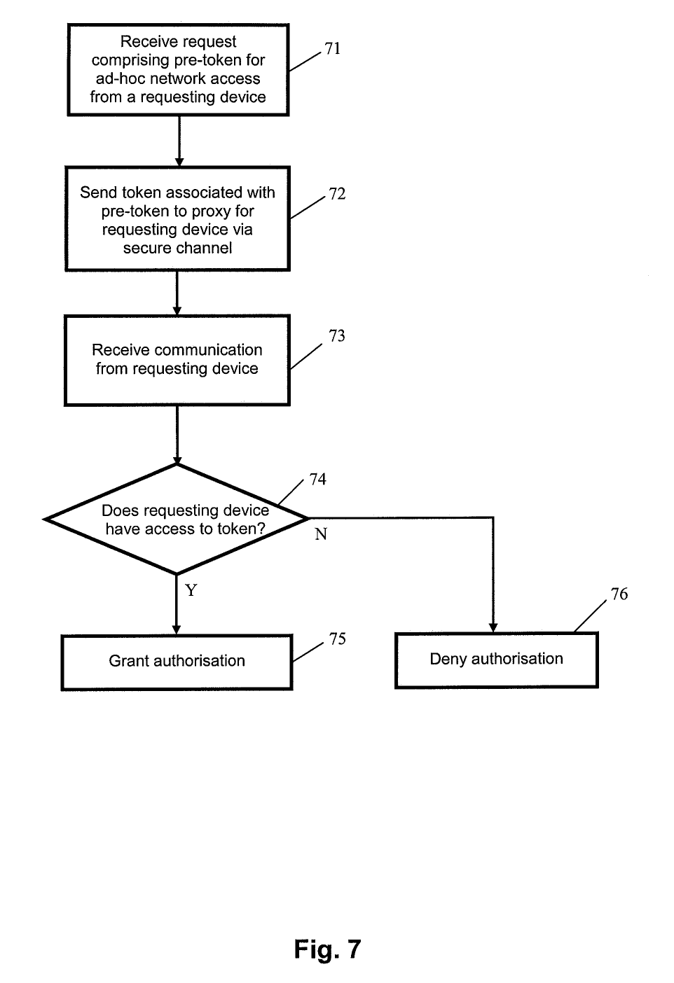

FIG. 7 shows a flow diagram of a method for managing ad-hoc network access.

Referring to FIG. 7, a request for ad-hoc access is received from a requesting device at step 71. The request comprises a pre-token previously sent to the requesting device via an unsecured communication channel. At step 72, an access token is sent to a proxy for the requesting device via a secure communications channel. The access token corresponds to or is associated with the pre-token. At step 73, a further communication is received from the requesting device for the purpose of proving that the requesting device has access to the access token sent to the proxy via a secure channel in step 72. At step 74, a determination is made whether the requesting device has access to the token. The determination is made based on the content of the communication of step 73. For example, the communication may comprise information derived from or specific to the token. If yes (Y), authorization is granted at step 75. If not (N), authorization is denied at step 76.

The communication of step 73 may be in response to a challenge sent to the requesting device and a further determination may optionally be made at step 74 whether the requesting device has received a random number issued with the challenge.

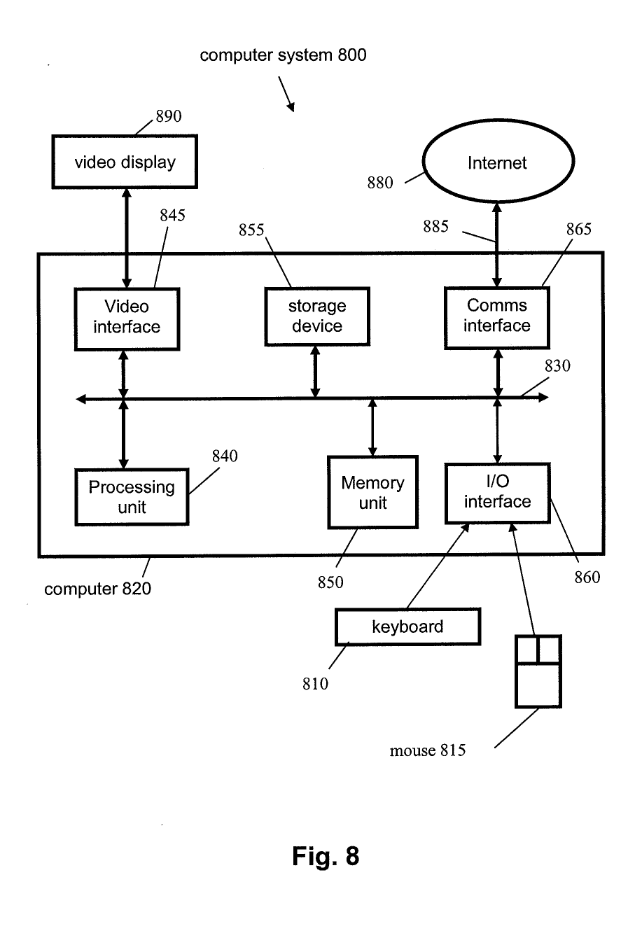

FIG. 8 shows a schematic block diagram of a computer system 800 that can be used to practise the methods and systems described herein. More specifically, the computer system 800 is provided for executing computer software that is programmed to assist in performing the methods described herein. The computer system 800 may also be used for executing computer software that is programmed to assist in performing the functions of devices described herein such as an authorization authority, an authorization controller and a distribution proxy. The computer software executes under an operating system such as MS Windows 2000, MS Windows XP™ or Linux™ installed on the computer system 800.

The computer software involves a set of programmed logic instructions that may be executed by the computer system 800 for instructing the computer system 800 to perform predetermined functions specified by those instructions. The computer software may be expressed or recorded in any language, code or notation that comprises a set of instructions intended to cause a compatible information processing system to perform particular functions, either directly or after conversion to another language, code or notation.

The computer software program comprises statements in a computer language. The computer program may be processed using a compiler into a binary format suitable for execution by the operating system. The computer program is programmed in a manner that involves various software components, or code, that perform particular steps of the methods described hereinbefore.

The components of the computer system 800 comprise: a computer 820, input devices 810, 815 and a video display 890. The computer 820 comprises: a processing unit 840, a memory unit 850, an input/output (I/O) interface 860, a communications interface 865, a video interface 845, and a storage device 855. The computer 820 may comprise more than one of any of the foregoing units, interfaces, and devices.

The processing unit 840 may comprise one or more processors that execute the operating system and the computer software executing under the operating system. The memory unit 850 may comprise random access memory (RAM), read-only memory (ROM), flash memory and/or any other type of memory known in the art for use under direction of the processing unit 840.

The video interface 845 is connected to the video display 890 and provides video signals for display on the video display 890. User input to operate the computer 820 is provided via the input devices 810 and 815, comprising a keyboard and a mouse, respectively. The storage device 855 may comprise a disk drive or any other suitable non-volatile storage medium.

Each of the components of the computer 820 is connected to a bus 830 that comprises data, address, and control buses, to allow the components to communicate with each other via the bus 830.

The computer system 800 may be connected to one or more other similar computers via the communications interface 865 using a communication channel 885 to a network 880, represented as the Internet. Multiple communications interfaces may also be practised, for example, to additionally connect to a Personal Area Network (PAN).

The computer software program may be provided as a computer program product, and recorded on a portable storage medium. In this case, the computer software program is accessible by the computer system 800 from the storage device 855. Alternatively, the computer software may be accessible directly from the network 880 by the computer 820. In either case, a user can interact with the computer system 800 using the keyboard 810 and mouse 815 to operate the programmed computer software executing on the computer 820.

The computer system 800 has been described for illustrative purposes. Accordingly, the foregoing description relates to an example of a particular type of computer system such as a personal computer (PC), which is suitable for practicing the methods and computer program products described hereinbefore. Those skilled in the computer programming arts would readily appreciate that alternative configurations or types of computer systems may be used to practise the methods and computer program products described hereinbefore. For example, the methods and computer program products described hereinbefore may be practised using computer platforms including static and mobile computer systems, handheld computers such as a Personal Digital Assistant (PDA) and mobile telephones.

Appendix 1, hereinafter, contains examples of messages, instructions and tokens generated in XML format in accordance with an embodiment of the present invention.

The foregoing detailed description provides exemplary embodiments only, and is not intended to limit the scope, applicability or configurations of the invention. Rather, the description of the exemplary embodiments provides those skilled in the art with enabling descriptions for implementing an embodiment of the invention. Various changes may be made in the function and arrangement of elements without departing from the spirit and scope of the invention as set forth in the claims hereinafter.

Where specific features, elements and steps referred to herein have known equivalents in the art to which the invention relates, such known equivalents are deemed to be incorporated herein as if individually set forth. Furthermore, features, elements and steps referred to in respect of particular embodiments may optionally form part of any of the other embodiments unless stated to the contrary.

### APPENDIX 1

Messages, instructions and tokens described hereinbefore can, for example, be generated in XML format. However, such may alternatively be generated using another format having similar parameters for passing information. Furthermore, XML encryption can be used to encrypt the messages, instructions and tokens to provide additional security to that provided by a secured channel.

The examples in this appendix relate to messages, instructions and tokens generated in XML format in accordance with a specific embodiment of the present invention. Accordingly, the structures and parameters of the messages, instructions and tokens in this appendix are intended as examples only and are not intended to limit the scope of the present invention.

TABLE 2
Access Token

<message id=pre-tokenxxx>
<pre-token>

<pre-token_ID> preTokenID </pre-token_ID>
<pre-token_key> preTokenKey </pre-token_key> //optional
<NetRequestPoint>AuthorisationControllerAddress</NetRequestPoint> //optional

</pre-token>
<access_token>

<access_token_ID> AccessTokenID </ access_token_ID >
<access_token_key> AccessTokenKey> </access_token_key>
<NetRequestPoint> AuthorisationControllerAddress </NetRequestPoint>
<StartValid_Time> StartTime</StartValid_Time> //optional
<EndtValid_Time> EndTime</EndValid_Time> //optional
<ValidTag> Yes/No</ValidTag> // optional
<pre-token_ID> AssociatedPre-token </pre-token_ID>
<pre-token_key> AssociatedPre-tokenKey </pre-token_key> //optional

</access_token>

TABLE 3
Instruction from Authorization Authority
to grant access to a Requesting Device

<message id = TempAccessGrant>

<grant_status> OK </grant_status>
<accesstoken> AccessToken </accesstoken>
<RequestingDeviceID> DeviceID </RequestingDeviceID>
<PANID> PANID <PANID>

<message>

TABLE 4
Message from Authorization Authority
invalidating an access token

<message id = InvalidateAccessToken>

<accesstoken> AccessToken </accesstoken>

<message>

We claim:

1. A method for granting a requesting device ad-hoc access to a network, said method comprising the steps of:
sending an access pre-token via an unsecured communication channel to said requesting device;
sending an access token associated with said access pre-token via a secure communications channel to a proxy device having a security association with said requesting device; and
granting ad-hoc network access to said requesting device subject to said requesting device providing information derived from said access token.

2. The method of claim 1, wherein said information derived from said access token comprises information specific to said access token.

3. The method of claim 1, wherein said information derived from said access token comprises cryptographic key information retrieved from said access token.

4. The method of claim 3, comprising the further step of forming a security association with said requesting device using said cryptographic key information.

5. The method of claim 1, comprising the further step of receiving a request for ad-hoc network access from the requesting device via an unsecured communication channel, and wherein said access pre-token and said access token are sent in response to said request.

6. The method of claim 1, comprising the further steps of:
issuing a challenge to said requesting device; and
receiving a response to said challenge, said response comprising information derived from said access token.

7. The method of claim 6, wherein said challenge comprises a random number and said step of granting ad-hoc network access to said requesting device is further subject to said response comprising information relating to said random number.

8. A system for granting a requesting device ad-hoc access to a network, said system comprising:
an authorization authority for authorizing access to said network by said requesting device; and
an authorization controller for granting ad-hoc network access to said authorized requesting device;
wherein an access token is sent by said authorization controller via a secure channel to a distribution proxy having a secure association with said requesting device; and
wherein said authorization is subject to said authorization controller receiving information derived from said access token from said requesting device.

9. The system of claim 8, wherein said information derived from said access token comprises information specific to said access token.

10. The system of claim 8, wherein said information derived from said access token comprises cryptographic key information retrieved from said access token.

11. The system of claim 10, further comprising means for forming a security association with said requesting device using said cryptographic key information.

12. The system of claim 8, wherein said authorization authority comprises:
reception means for receiving a request for ad-hoc network access from said requesting device via an unsecured communication channel; and
transmission means for sending an access pre-token and an access token in response to said request.

13. The system of claim 8, wherein said authorization controller further comprises:
transmission means for issuing a challenge to said requesting device; and
reception means for receiving a response to said challenge from said requesting device.

14. The system of claim 6, wherein said challenge comprises a random number and said authorization is further subject to said response comprising information relating to said random number.

15. A computer program product comprising a computer readable medium comprising a computer program recorded therein for granting a requesting device ad-hoc access to a network, said computer program product comprising:
computer program code for sending an access pre-token via an unsecured communication channel to said requesting device;
computer program code for sending an access token associated with said access pre-token via a secure communications channel to a proxy device having a security association with said requesting device; and
computer program code for granting ad-hoc network access to said requesting device subject to said requesting device providing information derived from said access token.

16. The computer program product of claim 15, wherein said information derived from said access token comprises information specific to said access token.

17. The computer program product of claim 15, wherein said information derived from said access token comprises cryptographic key information retrieved from said access token.

18. The computer program product of claim 17, further comprising computer program code for forming a security association with said requesting device using said cryptographic key information.

19. The computer program product of claim 15, further comprising computer program code for receiving a request for ad-hoc network access from the requesting device via an unsecured communication channel, and wherein said access pre-token and said access token are sent in response to said request.

20. The computer program product of claim 15, further comprising:
computer program code for issuing a challenge to said requesting device; and
computer program code for receiving a response to said challenge, said response comprising information derived from said access token.

21. The computer program product of claim 20, wherein said challenge comprises a random number and said step of granting ad-hoc network access to said requesting device is further subject to said response comprising information relating to said random number.

22. A method for managing ad-hoc network access, said method comprising the steps of:
receiving a request for ad-hoc access from a device, said request comprising a pre-token sent to said device via an unsecured communication channel;
sending a token associated with said pre-token via a secure communications channel to a proxy for said device in response to said request;
receiving a communication from said device; and
determining whether to grant said ad-hoc access based on the content of said communication.

23. A system for managing ad-hoc network access, comprising:
at least one communications interface for transmitting and receiving data;
a memory unit for storing data and instructions to be performed by a processing unit; and
a processing unit coupled to said at least one communications interface and said memory unit, said processing unit programmed to:
receive a request for ad-hoc access from a device, said request comprising a pre-token sent to said device via an unsecured communication channel;
send a token associated with said pre-token via a secure communications channel to a proxy for said device in response to said request;
receive a communication from said device; and
determine whether to grant said ad-hoc access based on the content of said communication.

24. A computer program product comprising a computer readable medium comprising a computer program recorded therein for managing ad-hoc network access, said computer program product comprising:
computer program code for receiving a request for ad-hoc access from a device, said request comprising a pre-token sent to said device via an unsecured communication channel;
computer program code for sending a token associated with said pre-token via a secure communications channel to a proxy for said device in response to said request;
computer program code for receiving a communication from said device; and
computer program code for determining whether to grant said ad-hoc access based on the content of said communication.

25. A token for granting a requesting device ad-hoc access to an unsecured network, said token comprising:
an access pre-token for said requesting device to identify itself to an authorization controller during an ad-hoc request; and
an access token for enabling said requesting device to validly respond to a challenge issued by said authorization controller to gain ad-hoc access to said unsecured network.

26. The token of claim 25, wherein said access pre-token is sent to said requesting device via an unsecured communications channel and said access token is sent to a proxy for said requesting device via a secured communications channel.

27. The token of claim 25, wherein said access pre-token comprises identification information for matching said access pre-token to said access token.

28. The token of claim 25, wherein said access pre-token comprises a key for securing a communication channel during an ad-hoc access request.

29. The token of claim 25, wherein said access token comprises:
information for identifying a network location of an authorization controller to said requesting device issuing said ad-hoc access request;
identification information for matching said access pre-token to said access token; and
a key for securing a communication channel between the authorization controller and the requesting device.

30. The token of claim 29, wherein said access token comprises one or more items selected from the group of items consisting of:
a validity tag for indicating validity or invalidity of said access token; and
a validity time for indicating a validity lifetime of said access token.

31. The token of claim 29, wherein said access pre-token is used to secure a communications channel when said requesting device issues a request for ad-hoc access to said unsecured network.
